(19) United States
(12) Patent Application Publication
(10) Pub. No.: US 2023/0359023 A1
(43) Pub. Date: Nov. 9, 2023

(54) MICROMECHANICAL RESONATOR ASSEMBLY WITH EXTERNAL ACTUATOR

(71) Applicants: HUAWEI TECHNOLOGIES CO., LTD., Shenzhen (CN); FRAUNHOFER-GESELLSCHAFT ZUR FOERDERUNG DER ANGEWANDTEN FORSCHUNG E.V., Muenchen (DE)

(72) Inventors: Stephan MARAUSKA, Itzehoe (DE); Ulrich HOFMANN, Itzehoe (DE); Christian JANICKE, Itzehoe (DE); Berkan ZORLUBAS, Itzehoe (DE); Saskia SCHROEDER, Itzehoe (DE); Joerg ALBERS, Itzehoe (DE); Felix HEINRICH, Itzehoe (DE); Yong CAO, Munich (DE)

(21) Appl. No.: 18/196,737

(22) Filed: May 12, 2023

Related U.S. Application Data
(63) Continuation of application No. PCT/EP2020/081826, filed on Nov. 12, 2020.

(51) Int. Cl. G02B 26/10; G02B 26/08

(52) U.S. Cl. CPC G02B 26/101; G02B 26/0833

(57) ABSTRACT

A micromechanical resonator assembly which includes an internal actuator. The internal actuator further includes an oscillation body configured to oscillate about one or more axes, the oscillation body having one or more eigen frequencies. The micromechanical resonator assembly further includes an external actuator that includes an oscillating part. The micromechanical resonator assembly further includes a mounting base that includes electronic driving part. The external actuator being mounted on the mounting base and being electrically connected to the electronic driving part, for allowing excitation of the oscillation body of the internal actuator by transfer of energy from the oscillating part to the oscillating body. The micromechanical resonator assembly provides external actuation of the oscillation body of the internal actuator by use of the external actuator and hence, provides extremely large scan angles of 180°.

### TECHNICAL FIELD

The present disclosure relates generally to the field of micro-electro-mechanical devices, and more specifically, to a micromechanical resonator assembly with an external actuator.

### BACKGROUND

Generally, micro-electro-mechanical system (MEMS) is a technology that is defined in terms of miniaturized mechanical or electromechanical elements which are made of using microfabrication techniques. Typically, physical dimensions of the mechanical or electromechanical elements varies from one micrometer to hundreds of micrometer (100×10⁻⁶).

Typically, a conventional micromechanical resonator (e.g. a conventional micromechanical resonator assembly) may include MEMS mirrors which are actuated either by use of internal piezo-electric thin film layers, or electrostatic comb drives, or by magnetic force stimulation. The conventional micromechanical resonator based on aforesaid internal actuation solutions has limited actuation energy and therefore, manifests short scan angles for one dimensional (1D) as well as two dimensional (2D) conventional MEMS mirrors. The reason behind the limited actuation energy is low energy transfer from a conventional actuation structure to the MEMS mirrors of the conventional micromechanical resonator. Moreover, existing micromechanical resonators manifest high power consumption and slow start-up time, which is not desirable. It is observed that externally actuating the conventional MEMS mirrors of the conventional micromechanical resonator does not manifest an optimal actuation geometry hence, does not provide a satisfactory performance. Thus, there exists a technical problem of an inefficient micromechanical resonator that manifests short scan angles, high power consumption, slow start-up time and also a high manufacturing cost.

Therefore, in light of the foregoing discussion, there exists a need to overcome the aforementioned drawbacks associated with conventional micromechanical resonators.

### SUMMARY

The present disclosure seeks to provide a micromechanical resonator assembly with an external actuator that manifests extremely large scan angles, low power consumption, fast start-up time and also a low manufacturing cost. The present disclosure seeks to provide a solution to the existing problem of an inefficient micromechanical resonator that manifests short scan angles, high power consumption, slow start-up time and also a high manufacturing cost. An aim of the present disclosure is to provide a solution that overcomes at least partially the problems encountered in the prior art and provides an improved micromechanical resonator assembly with extremely large scan angles at low power consumption.

The object of the present disclosure is achieved by the solutions provided in the enclosed independent claims. Advantageous implementations of the present disclosure are further defined in the dependent claims.

In one aspect, the present disclosure provides a micromechanical resonator assembly comprising an internal actuator which comprises an oscillation body configured to oscillate about one or more axes, the oscillation body having one or more eigen frequencies. The micromechanical resonator assembly further comprises an external actuator which comprises an oscillating part. The micromechanical resonator assembly further comprises a mounting base which comprises electronic driving part. The internal actuator being mounted with the external actuator so as to form a coupled oscillation system. The external actuator being mounted on the mounting base and being electrically connected to the electronic driving part, for allowing excitation of the oscillation body of the internal actuator by transfer of energy from the oscillating part to the oscillation body.

The micromechanical resonator assembly of the present disclosure provides external actuation of the oscillation body of the internal actuator by use of the external actuator. Therefore, high actuation energy is transferred to the oscillation body in comparison to a conventional micromechanical resonator. The conventional micromechanical resonator uses internal actuation of a conventional oscillation body which results in to low energy transfer and hence, manifests short scan angles. The disclosed micromechanical resonator assembly provides extremely large scan angles that is from 110° to 180° for one dimensional (1D) oscillation body because of the transfer of high actuation energy to the oscillation body. The disclosed micromechanical resonator assembly provides extremely fast start-up time that is reduced from 10 s down to <1 s in comparison to the conventional micromechanical resonator. Moreover, the disclosed micromechanical resonator assembly is manufacturable at high volume because of the use of semiconductor assembly process. The disclosed micromechanical resonator assembly is cost efficient and has robust quality. Additionally, the disclosed micromechanical resonator assembly provides a reduced power consumption and easy handling when in operation.

In an implementation form, the electrical connection between the external actuator and the driving part comprises at least one ground connection and two sensing signal connections.

The electrical connection between the external actuator and the driving part provides an effective excitation (or actuation energy) to the oscillation body of the internal actuator by virtue of a driving signal that is provided by the driving part. The driving signal excites resonant or near resonant oscillation (or eigen frequency) of the oscillation body of the internal actuator which enables the disclosed micromechanical resonator assembly to achieve extremely large scan angles that is 180° for one dimensional (1D) oscillation body with reduced power consumption. The ground connection completes the electrical connections of the micromechanical resonator assembly. The two sensing signal connections (e.g. a voltage and a current signal) are used to provide the actuation energy to the internal actuator.

In a further implementation form, the electrical connection between the external actuator and the driving part is obtained through wire bonding.

The wire bonding technique is used to internally connect the external actuator and the driving part. The wire bonding technique provides a cost effective solution to the micromechanical resonator assembly.

In a further implementation form, the external actuator is mounted on the mounting base by mechanical fixation such as clamping, or by gluing.

The mounting of the external actuator on the mounting base by use of the clamping (e.g. a screw fixation) provides a mechanical strength to the mount. Additionally, use of the clamping or gluing for mounting of the external actuator on the mounting base reduces the manufacturing cost of the micromechanical resonator assembly.

In a further implementation form, the electrical connection between the external actuator and the driving part is obtained through direct soldering of the external actuator onto the mounting base, so as to ensure both electrical connection and fixation of the external actuator on the mounting base.

By virtue of direct soldering of the external actuator onto the mounting base, the electrical connection between the external actuator and the driving part is obtained as well as fixation of the external actuator with the mounting base is achieved. This further results into robustness and easy handling of the micromechanical resonator assembly when in operation and low fabrication cost as well.

In a further implementation form, the internal actuator comprises an internal sensor electrically connected to the driving part, such as to allow reading out by the driving part of a position feedback signal of the oscillation body.

The reading out of the position feedback signal of the oscillation body by the driving part leads to a stable amplitude operation of the oscillation body.

In a further implementation form, wherein the electrical connection between the internal sensor and the driving part is obtained by wire bonding or flexible cable soldering.

The use of the wire bonding or flexible cable soldering for the electrical connection between the internal sensor and the driving part provides a flexibility to the micromechanical resonator assembly and reduces the manufacturing cost as well.

In a further implementation form, the internal actuator is mounted on the external actuator by gluing.

The mounting of the internal actuator on the external actuator by gluing results into the low fabrication cost.

In a further implementation form, the electrical connection between the internal sensor and the driving part is obtained by direct soldering of the internal sensor onto the external actuator, so as to ensure both electrical connection and fixation of the internal sensor on the external actuator.

The direct soldering of the internal sensor onto the external actuator provides the electrical connection between the internal sensor and the driving part and also the fixation of the internal sensor onto the external actuator. Additionally, the direct soldering provides the robustness to the micromechanical resonator assembly when in operation.

In a further implementation form, the external actuator comprises at least two ends and is mounted on the mounting base by one of said two ends, the internal actuator being mounted on the external actuator at the other one of said two ends.

The mounting of the external actuator on the mounting base at the one end and the mounting of the internal actuator on the external actuator at the other end provides robustness and compactness to the micromechanical resonator assembly.

In a further implementation form, the external actuator comprises at least two ends and is mounted on the mounting base by each of said two ends, the internal actuator being mounted on the external actuator between said two ends.

The mounting of the external actuator on the mounting base by use of both the ends provides robustness to the micromechanical resonator assembly. And mounting of the internal actuator between the two ends of the external actuator provides more robustness to the micromechanical resonator assembly and easy handling as well.

In a further implementation form, the external actuator has a circular shape and is mounted on the mounting base by a portion of its periphery, the internal actuator being mounted on the external actuator at the centre of said external actuator.

In an example, the external actuator has the circular shape. The mounting of the external actuator on the mounting base by the portion of its periphery provides robustness. And mounting of the internal actuator at the centre of the external actuator provides effective actuation energy to the oscillation body of the internal actuator.

In a further implementation form, the external actuator comprises an opening, the internal actuator comprising a mirror plate and being mounted on the external actuator so as to cover said opening on a first side of said external actuator, and so as to create an optical path from a light source, located on a second side opposite to said first side, to the mirror plate through said opening.

The optical path from the light source to the mirror plate through the opening provides reflection of light at a desired angle. Additionally, the internal actuator can be directly soldered onto the external actuator by use of the opening in the external actuator. The direct soldering of the internal actuator onto the external actuator provides the electrical connection with driving part as well as fixation of the internal actuator onto the external actuator

In a further implementation form, the micromechanical resonator assembly being a micro mirror scanner, the external actuator being a piezoelectric actuator and the internal actuator comprising a piezoelectric or electrostatic sensor.

In an example, the micromechanical resonator assembly is used as the micro-mirror scanner to provide a dynamic light modulation. The external actuator is used as the piezoelectric actuator and the internal actuator as the piezoelectric or electrostatic sensor in order to control a modulatory movement of a single mirror of the micro-mirror scanner for the dynamic light modulation.

In a further implementation form, the external piezoelectric actuator comprises at least one piezo electric layer and at least one passive layer, and is mounted on the mounting base through its passive layer.

The external piezoelectric actuator is used to actuate the internal actuator through the piezo electric layer and is mounted on the mounting base through the passive layer in order to mitigate unwanted vibrations, if any.

In a further implementation form, the external piezoelectric actuator is segmented so as to comprise a plurality of segments each exhibiting different bending and torsion axis excitation frequency.

The plurality of segments of the external piezoelectric actuator exhibit different bending and torsion axis excitation frequency which further results into different polarization angles of the external actuator and different torsion oscillation modes.

In a further implementation form, the oscillation body of the internal actuator comprises a wafer-level vacuum encapsulated spring-mirror plate system.

The oscillation body of the internal actuator comprises the wafer-level vacuum encapsulated spring-mirror plate system in order to reduce an air damping effect while simultaneously results into a high quality factor (Q factor) of the micromechanical resonator assembly.

In another aspect, the present disclosure provides a light engine for laser scanning or laser projection system comprising the said micromechanical resonator assembly.

The light engine for laser scanning or laser projection system comprising the micromechanical resonator assembly achieves all the advantages and effects of the micromechanical resonator assembly of the present disclosure.

In an implementation form, laser projection or scanning system comprising said light engine, such as AR/VR glasses or helmet, or a Lidar system.

The laser projection or scanning system comprising the light engine finds application in augmented reality (AR) or virtual reality (VR) glasses or helmet, or the light detection and ranging (LiDAR) system, which provides extremely large scan angles that is from 110° to 180° and extremely fast start-up time that is less than Is. Additionally, the laser projection or scanning system comprising the light engine manifest low power consumption.

In a yet another aspect, the present disclosure provides a method of fabricating a micromechanical resonator assembly comprising an internal actuator which comprises an oscillation body configured to oscillate about one or more axis. The micromechanical resonator assembly further comprises an external actuator which comprises an oscillating part. The micromechanical resonator assembly further comprises a mounting base which comprises electronic driving part. The method further comprises mounting the internal actuator on the external actuator so as to form a coupled oscillating system. The method further comprises mounting the external actuator on the mounting base so as to electrically connect the external actuator to the electronic driving part, for allowing excitation of the oscillation body of the internal actuator by transfer of energy from the oscillating part to the oscillation body.

The present disclosure provides the method of fabricating the micromechanical resonator assembly which has an optimal actuation geometry of the internal actuator and the external actuator. Additionally, the method provides the specific mounting and assembly details of the micromechanical resonator assembly. Moreover, the micromechanical resonator assembly fabricated by use of the presented method achieves extremely large scan angles upto 180° and extremely fast start-up time which is less than Is with low power consumption.

In an implementation form, the electrical connection between the external actuator and the driving part is obtained through wire bonding.

The wire bonding technique is used to internally connect the external actuator and the driving part. The wire bonding technique provides a cost effective solution to the micromechanical resonator assembly

In a further implementation form, the external actuator is mounted on the mounting base by mechanical fixation such as clamping, or by gluing.

The use of clamping or gluing for mounting the external actuator on the mounting base reduces the manufacturing cost of the micromechanical resonator assembly.

In a further implementation form, the electrical connection between the external actuator and the driving part is obtained through direct soldering of the external actuator onto the mounting base, so as to ensure both electrical connection and fixation of the external actuator on the mounting base.

The direct soldering of the external actuator onto the mounting base results into robustness and easy handling of the micromechanical resonator assembly when in operation and low fabrication cost as well.

In a further implementation form, the internal actuator comprising an internal sensor. The method further comprises electrically connecting the internal sensor to the driving part, such as to allow reading out by the driving part of a position feedback signal of the oscillation body.

The reading out of the position feedback signal of the oscillation body by the driving part leads to a stable amplitude operation of the oscillation body.

In a further implementation form, the electrical connection between the internal sensor and the driving part is obtained by wire bonding or flexible cable soldering.

The use of the wire bonding or flexible cable soldering for the electrical connection between the internal sensor and the driving part provides reduces complexity to fabricate the micromechanical resonator assembly and reduces the manufacturing cost as well.

In a further implementation form, the internal actuator is mounted on the external actuator by gluing.

The mounting of the internal actuator on the external actuator by gluing reduces the fabrication cost of the micromechanical resonator assembly.

In a further implementation form, the electrical connection between the internal sensor and the driving part is obtained by direct soldering of the internal sensor onto the external actuator, so as to ensure both electrical connection and fixation of the internal sensor on the external actuator.

The direct soldering of the internal sensor onto the external actuator provides the electrical connection between the internal sensor and the driving part and also the fixation of the internal sensor on the external actuator. Additionally, the direct soldering provides the robustness to the micromechanical resonator assembly when in operation.

In a further implementation form, the method further comprises creating an opening in the external actuator prior to mounting the internal actuator on the external actuator, said internal actuator comprising a mirror plate, and mounting said internal actuator on the external actuator so as to cover said opening on a first side of said external actuator, such that an optical path is created from a light source, located on a second side opposite to said first side, to the mirror plate through said opening.

The method of creating the opening in the external actuator provides the optical path for transferring the light from the light source to the mirror plate which further results into reflection of the light at a desired reflection angle. Through the opening in the external actuator, the internal actuator can be directly soldered onto the external actuator.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings.

For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1A is a schematic side view of a micromechanical resonator assembly, in accordance with an embodiment of the present disclosure;

FIG. 1B is a schematic top view of the micromechanical resonator assembly of FIG. 1A, in accordance with an embodiment of the present disclosure;

FIG. 1C is a schematic side view of the micromechanical resonator assembly of FIG. 1A, in accordance with another embodiment of the present disclosure;

FIG. 1D is a schematic top view of the micromechanical resonator assembly of FIG. 1A, in accordance with another embodiment of the present disclosure;

FIG. 2 is a flowchart of a method of fabricating a micromechanical resonator assembly, in accordance with an embodiment of the present disclosure;

FIG. 3A is a schematic side view of a micromechanical resonator assembly, in accordance with another embodiment of the present disclosure;

FIG. 3B is a schematic side view of a micromechanical resonator assembly, in accordance with yet another embodiment of the present disclosure;

FIG. 3C is a schematic side view of a micromechanical resonator assembly, in accordance with yet another embodiment of the present disclosure;

FIG. 3D is a schematic side view of a micromechanical resonator assembly, in accordance with yet another embodiment of the present disclosure;

FIG. 3E is a schematic top view of the micromechanical resonator assembly of FIG. 3D, in accordance with an embodiment of the present disclosure;

FIG. 4 is a flowchart of a method that depicts fabrication details of a micromechanical resonator assembly, in accordance with an embodiment of the present disclosure;

FIG. 5 is a schematic top view of a micromechanical resonator assembly, in accordance with another embodiment of the present disclosure;

FIG. 6 is a schematic top view of a micromechanical resonator assembly, in accordance with yet another embodiment of the present disclosure; and

FIG. 7 is an illustration of an exemplary implementation of a micromechanical resonator assembly in a laser scanning or laser projection system, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

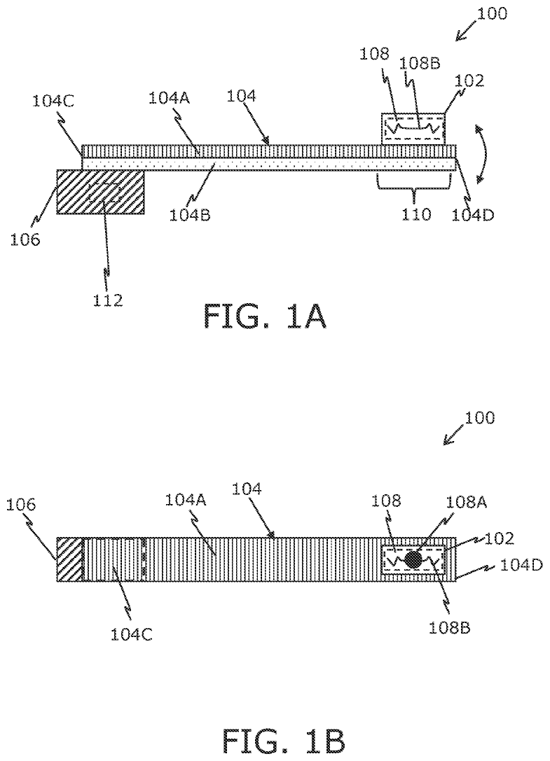

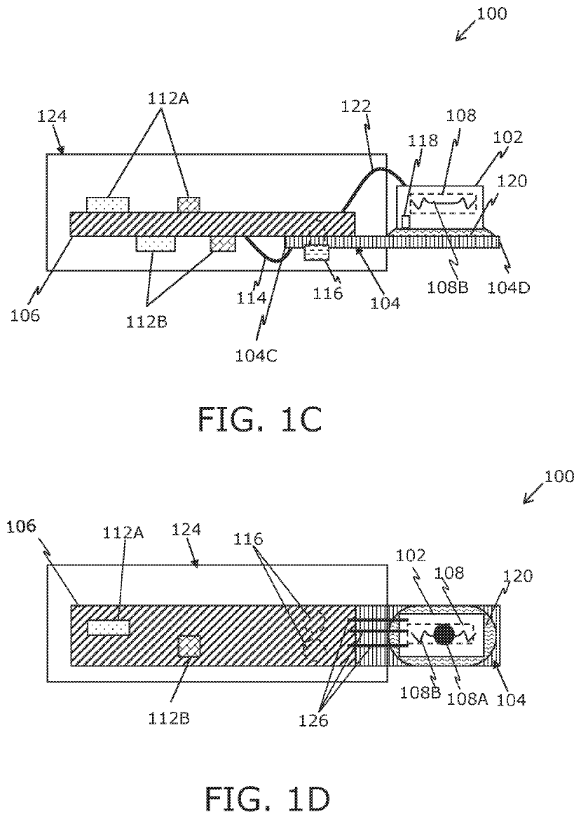

FIG. 1A is a schematic side view of a micromechanical resonator assembly, in accordance with an embodiment of the present disclosure. With reference to FIG. 1A, there is shown a micromechanical resonator assembly 100 that comprises an internal actuator 102, an external actuator 104, and a mounting base 106. The internal actuator 102 comprises an oscillation body 108. The oscillation body 108 includes a micro mirror plate 108A and a spring 108B. The external actuator 104 comprises a piezoelectric layer 104A, a passive layer 104B, a first end 104C, a second end 104D and an oscillating part 110. The mounting base 106 comprises an electronic driving part 112. The oscillation body 108 is represented by a dashed rectangular box which is used for illustration purpose only and does not form a part of circuitry.

The micromechanical resonator assembly 100 is an improved micro-electro-mechanical system (MEMS) device that provides extremely large scan angles from 110° to 180° for one dimensional (1D) oscillation body such as the oscillation body 108. The micromechanical resonator assembly 100 provides external actuation of the oscillation body 108 of the internal actuator 102 by use of the external actuator 104 and hence, manifests high actuation energy in comparison to a conventional micromechanical resonator. The micromechanical resonator assembly 100 is used in light projection systems. Examples of such light projection systems include, but is not limited to a laser projection system, a laser scanning system, light detection and ranging (LiDAR) system. Augmented Reality (AR) and Virtual Reality (VR) based glasses, helmets, and the like.

The internal actuator 102 is configured for energy conversion such as electrical, air or hydraulic energy into a mechanical energy such as a mechanical movement or vice-versa. The internal actuator 102 may also be referred as a micro mirror chip which includes a mirror plate (or an array of mirror plates). In an implementation, the internal actuator 102 may include either a piezoelectric sensor, or an electrostatic sensor or actuator elements. The internal actuator 102 comprises the oscillation body 108. The micro mirror plate 108A (not visible in FIG. 1A) mounted on the spring 108B collectively constitutes the oscillation body 108. The oscillation body 108 may also be referred as MEMS mirrors or MEMS mirror arrays of the internal actuator 102.

The oscillation body 108 (i.e. the micro mirror plate 108A mounted on the spring 108B) of the internal actuator 102 is configured to oscillate about one or more axis hence, the oscillation body 108 has one or more eigen frequencies. Generally, an eigen frequency is defined as a frequency at which an oscillation system such as the oscillation body 108, tends to oscillate in absence of any driving force or a damping force. Therefore, the eigen frequency is also referred as a natural frequency or a resonant frequency.

The external actuator 104 is configured to provide an actuation energy to the oscillation body 108 (i.e. the micro mirror plate 108A mounted on the spring 108B) of the internal actuator 102. The oscillating part 110 of the external actuator 104 is configured to perform a bending mode vibration on applying a drive signal (e.g. a voltage signal or a current signal) through the piezoelectric layer 104A of the external actuator 104. The bending mode vibration of the oscillating part 110 transfers an actuation energy to the oscillation body 108 (i.e. the micro mirror plate 108A mounted on the spring 108B). The actuation energy tends the oscillation body 108 to oscillate about its axis. The external actuator 104 transfers the actuation energy to the oscillation body 108 by use of the piezoelectric layer 104A. The external actuator 104 may also be referred as an external piezoelectric actuator. In this embodiment, the external actuator 104 has a rectangular shape, however, in another embodiment, the external actuator 104 may have a different shape such as circular, elliptical or trapezoidal.

The mounting base 106 comprises the electronic driving part 112 which is configured to drive and read out the internal actuator 102 and the external actuator 104 of the micromechanical resonator assembly 100. In an implementation, the mounting base 106 may also be referred as a mounting printed circuit board (PCB). The electronic driving part 112 may also be referred as an electronic component or a combination of electronic components such as amplifiers, capacitors and the like.

In operation, the internal actuator 102 is mounted with the external actuator 104 so as to form a coupled oscillation system. The external actuator 104 is mounted on the mounting base 106 and is electrically connected to the electronic driving part 112, for allowing excitation of the oscillation body 108 of the internal actuator 102 by transfer of energy from the oscillating part 110 to the oscillation body 108. The external actuator 104 is electrically connected to the electronic driving part 112. Therefore, on applying an amplitude changing drive signal frequency (e.g. a sinusoidal signal) to the piezoelectric layer 104A of the external actuator 104, the oscillating part 110 performs a bending mode vibration which is indicated by a double sided arrow. The bending mode vibration of the oscillating part 110 transfers an actuation energy to the oscillation body 108 (i.e. the micro mirror plate 108A mounted on the spring 108B). The actuation energy causes the oscillation body 108 to oscillate about its axis. In this way, the oscillating part 110 of the external actuator 104 and the oscillation body 108 of the internal actuator 102 are configured to form the coupled oscillation system. The actuation energy transferred by the oscillating part 110 excites the one or more eigen (or resonant or near resonant) frequencies of the oscillation body 108 and effective enough to lead the oscillation body 108 to have extremely large scan angles of upto 180°.

In accordance with an embodiment, the electrical connection between the external actuator 104 and the driving part 112 comprises at least one ground connection and two sensing signal connections. The external actuator 104 is electrically connected to the electronic driving part 112 of the mounting base 106. The electrical connection includes one ground connection in order to complete the electrical connections of the micromechanical resonator assembly 100 and to set a reference for measurement of any voltage or current in the micromechanical resonator assembly 100. The two sensing signal connections, for example a voltage and a current signal, are used in order to apply actuation voltage or current to the external actuator 104 which is further used to excite the eigen frequency (i.e. resonant or near resonant frequency) of the oscillation body 108 of the internal actuator 102. The electrical connections of the internal actuator 102 and the external actuator 104 with the electronic driving part 112 are described in detail, for example, in FIG. 1C.

In accordance with an embodiment, the external actuator 104 comprises at least two ends and is mounted on the mounting base 106 by one of said two ends, the internal actuator 102 being mounted on the external actuator 104 at the other one of said two ends. In this embodiment, the external actuator 104 has the rectangular shape and includes two ends such as the first end 104C and the second end 104D. The external actuator 104 is mounted on the mounting base 106 at the first end 104C and the internal actuator 102 is mounted on the external actuator 104 at the second end 104D. Such arrangement of the internal actuator 102, the external actuator 104 and the mounting base 106 by use of the first end 104C and the second end 104D may also be referred as a one-sided (or single-sided) clamped external actuator and is described in detail, for example, in FIG. 1B.

In accordance with an embodiment, the external actuator 104 comprises at least two ends and is mounted on the mounting base 106 by each of said two ends, the internal actuator 102 being mounted on the external actuator 104 between said two ends. In an implementation, the external actuator 104 is mounted on the mounting base 106 by use of both the ends such as the first end 104C and the second end 104D. And the internal actuator 102 is mounted between the first end 104C and the second end 104D, that may be at centre or near to centre of the external actuator 104. The arrangement of the internal actuator 102 between the two ends (i.e. the first end 104C and the second end 104D) of the external actuator 104 may also be referred as a two-sided (or double sided) clamped external actuator and is described in detail, for example, in FIG. 5.

In accordance with an embodiment, the external actuator 104 has a circular shape and is mounted on the mounting base 106 by a portion of its periphery, the internal actuator 102 being mounted on the external actuator 104 at the centre of said external actuator 104. In another embodiment, the external actuator 104 has the circular shape. The mounting of the external actuator 104 on the mounting base 106 is performed by use of the portion of its periphery. The internal actuator 102 is mounted at the centre the external actuator 104. An exemplary implementation of the external actuator 104 having the circular shape is described in detail, for example, in FIG. 6.

In accordance with an embodiment, the micromechanical resonator assembly 100 being a micro mirror scanner, the external actuator 104 being a piezoelectric actuator and the internal actuator 102 comprising a piezoelectric or electrostatic sensor. The micromechanical resonator assembly 100 is a micro mirror scanner which is used to project a light (e.g. a laser light) at a certain angle. The external actuator 104 is a piezoelectric actuator which is used to induce mechanical movement (such as the bending mode vibration of the oscillating part 110) by use of the electrical energy (which is applied in the form of the voltage and the current signals as sensing signals). The internal actuator 102 comprises the piezoelectric or electrostatic sensor to provide the actuation energy (i.e. either electrical or mechanical energy) to the oscillation body 108 to make it oscillate about its axis.

In accordance with an embodiment, the external piezoelectric actuator 104 comprises at least one piezo electric layer 104A and at least one passive layer 104B, and is mounted on the mounting base 106 through its passive layer 104B. The external piezoelectric actuator 104 is mounted on the mounting base 106 through the passive layer 104B to avoid any unwanted vibration. The internal actuator 102 is mounted on the external actuator 104 through the piezoelectric layer 104A which is used to transfer the actuation energy (i.e. either electrical or mechanical energy) to the oscillation body 108 of the internal actuator 102. By virtue of the piezoelectric layer 104A and the passive layer 104B, the external actuator 104 forms a bi-morph structure. In another embodiment, the external actuator 104 may include either three layers or a plurality of layers and hence, form a tri-morph structure or a multi-layered structure, respectively.

In accordance with an embodiment, the external piezoelectric actuator 104 is segmented so as to comprise a plurality of segments each exhibiting different bending and torsion axis excitation frequency. In another embodiment, the external piezoelectric actuator 104 comprises the plurality of segments. The plurality of segments exhibit different polarization angles with respect to each other such as in-plane, out-of plane, or 450 polarization angle which further leads to different bending and torsion oscillation modes (or excitation frequency).

In accordance with an embodiment, the oscillation body 108 of the internal actuator 102 comprises a wafer-level vacuum encapsulated spring-mirror plate system. The oscillation body 108 of the internal actuator 102 includes the micro mirror plate 108A which is mounted on the spring 108B. The micro mirror plate 108A belongs to the wafer-level packaging technique so as to reduce the air damping effects. Alternatively stated, the micro mirror plate 108A belongs to the wafer-level vacuum encapsulated spring-mirror plate system. The wafer-level vacuum encapsulated spring-mirror plate system results into high quality factor (Q factor) of the micromechanical resonator assembly 100.

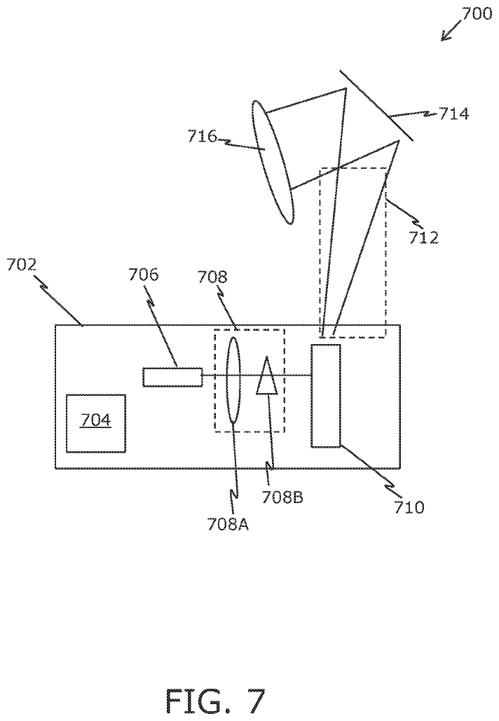

In accordance with an embodiment, the micromechanical resonator assembly 100 is used in a light engine for laser scanning or laser projection system. An exemplary implementation of the micromechanical resonator assembly 100 in the light engine for laser scanning or laser projection system is described in detail, for example, in FIG. 7.

In accordance with an embodiment, a laser projection or scanning system comprising the aforesaid light engine, such as AR/VR glasses or helmet, or a Lidar system. Examples of the laser projection or scanning system comprising the light engine include augmented reality (AR) or virtual reality (VR) glasses or helmets, light detection and ranging (LiDAR) system and the like. The light engine comprises the micromechanical resonator assembly 100 in order to project light at a certain angle on requirement basis. These systems provide extremely large scan angles up to 180° and extremely fast start-up time that is less than 1 s. Additionally, the laser projection or scanning system comprising the light engine operates at a low power consumption and has a robust quality.

FIG. 1B is a schematic top view of the micromechanical resonator assembly of FIG. 1A, in accordance with an embodiment of the present disclosure. FIG. 1B is described in conjunction with elements from FIG. 1A. With reference to FIG. 1B, there is shown a top view of the micromechanical resonator assembly 100 of FIG. 1A. In the top view, the micromechanical resonator assembly 100 appears to have a rectangular shape and a one-sided clamping of the external actuator 104. In the one-sided (or single-sided) clamping of the external actuator 104, the external actuator 104 is mounted on the mounting base 106 at the first end 104C and the internal actuator 102 is mounted on the external actuator 104 at the second end 104D. The micro mirror plate 108A of the oscillation body 108 appears to have a circular shape in the top view of the micromechanical resonator assembly 100.

FIG. 1C is a schematic side view of the micromechanical resonator assembly of FIG. 1A, in accordance with an embodiment of the present disclosure. FIG. 1C is described in conjunction with elements from FIGS. 1A and 1B. With reference to FIG. 1C, there is shown a side view of the micromechanical resonator assembly 100 of FIG. 1A. In the side view, the micromechanical resonator assembly 100 further includes a first wire 114, a screw 116, an internal sensor 118, a glue 120, a second wire 122 and a housing 124. There is further shown that the electronic driving part 112 of the mounting base 106 includes electronic components 112A and 112B.

The internal sensor 118 is configured to measure a change in a voltage, or current or any other physical quantity. The housing 124 protects the mounting base 106 and the electronic driving part 112 from dust particles. The housing 124 may be made of an insulating material, such as plastic.

In accordance with an embodiment, the electrical connection between the external actuator 104 and the driving part 112 is obtained through wire bonding. In this embodiment, the external actuator 104 is electrically connected to the driving part 112 through the first wire 114 by use of the wire bonding technique. The external actuator 104 is electrically connected to the driving part 112 so that an actuation voltage or current signal can be applied to the external actuator 104 in order to excite the one or more eigen frequencies of the oscillation body 108 of the internal actuator 102. The electronic components 112A and 112B of the driving part 112 are configured to provide the actuation voltage or current signal to the external actuator 104 in order to drive the external actuator 104 and read out the internal actuator 102 of the micromechanical resonator assembly 100. The electronic components 112A and 112B may include amplifiers, capacitors and the like. In another embodiment, a soldered wire may also be used to electrically connect the external actuator 104 to the driving part 112.

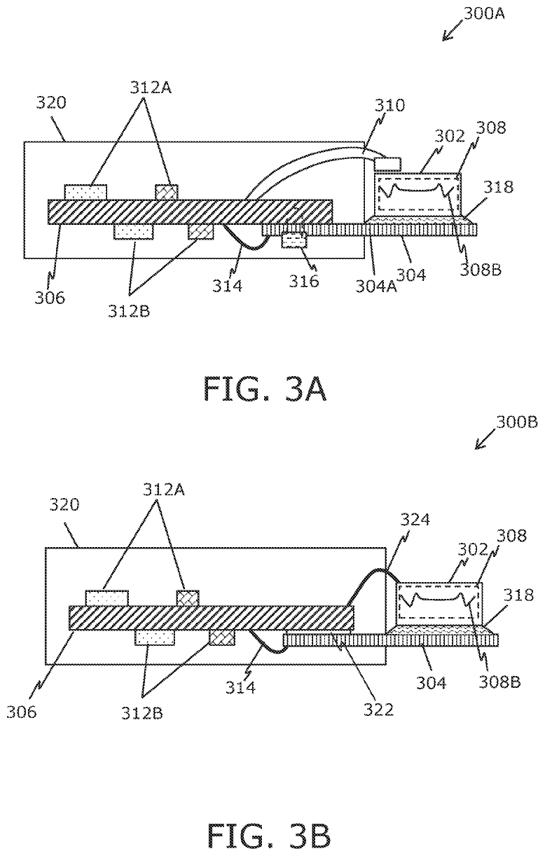

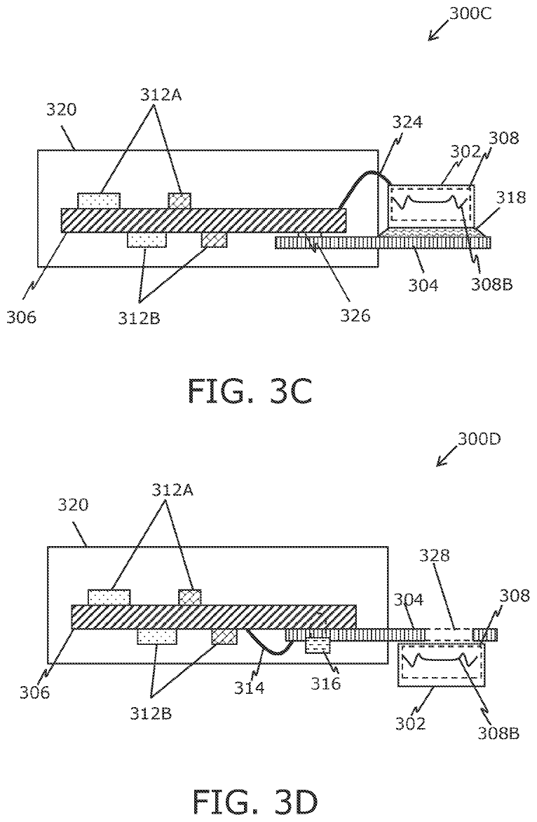

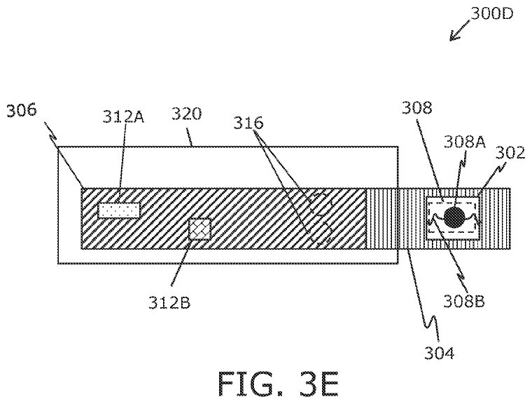

In accordance with an embodiment, the external actuator 104 is mounted on the mounting base 106 by mechanical fixation such as clamping, or by gluing. In this embodiment, the external actuator 104 is mounted on the mounting base 106 by use of the screw 116. The screw 116 provides a mechanical strength to the external actuator 104 and the mounting base 106 as well. In another embodiment, the external actuator 104 is mounted on the mounting base 106 by use of the gluing. An exemplary implementation of a glued external actuator is described in detail, for example, in FIG. 3B.

In accordance with an embodiment, the electrical connection between the external actuator 104 and the driving part 112 is obtained through direct soldering of the external actuator 104 onto the mounting base 106, so as to ensure both electrical connection and fixation of the external actuator 104 on the mounting base 106. The direct soldering of the external actuator 104 onto the mounting base 106 provides the electrical connection between the external actuator 104 and the driving part 112 so that an actuation voltage or current signal can be easily applied to the external actuator 104. Additionally, the direct soldering provides the fixation of the external actuator 104 on the mounting base 106. An exemplary implementation of the direct soldering of the external actuator 104 onto the mounting base 106 is described in detail, for example, in FIG. 3C.

In accordance with an embodiment, the internal actuator 102 comprises the internal sensor 118 electrically connected to the driving part 112, such as to allow reading out by the driving part 112 of a position feedback signal of the oscillation body 108. For a stable amplitude operation of the oscillation body 108 of the internal actuator 102, the external actuator 104 is driven in a closed loop by use of the internal sensor 118. The internal sensor 118 allows the driving part 112 to read out the position feedback signal of the oscillation body 108. The position feedback signal of the oscillation body 108 is applied to the closed loop which enables the external actuator 104 to control oscillations of the oscillation body 108 and results into the stable amplitude operation of the oscillation body 108.

In accordance with an embodiment, the electrical connection between the internal sensor 118 and the driving part 112 is obtained by wire bonding or flexible cable soldering. In this embodiment, the internal sensor 118 is electrically connected to the driving part 112 through the second wire 122 by use of the wire bonding technique. In another embodiment, the internal sensor 118 is electrically connected to the driving part 112 through the flexible cable soldering. An exemplary implementation of the flexible cable soldering for the electrical connection between the internal sensor 118 and the driving part 112 is described in detail, for example, in FIG. 3A.

In accordance with an embodiment, the internal actuator 102 is mounted on the external actuator 104 by gluing. The internal actuator 102 (or micro mirror chip) is mounted on the external actuator 104 by use of the glue 120. The glue 120 provides thermal insensitivity to the micromechanical resonator assembly 100. In another embodiment, the internal actuator 102 (or micro mirror chip) may be mounted on the external actuator 104 by use of soldering.

In accordance with an embodiment, electrical connection between the internal sensor 118 and the driving part 112 is obtained by direct soldering of the internal sensor 118 onto the external actuator 104, so as to ensure both electrical connection and fixation of the internal sensor 118 on the external actuator 104. The internal sensor 118 is mounted on the external actuator 104 by use of the direct soldering which provides the electrical connection between the internal sensor 118 and the driving part 112 and mechanical fixation of the the internal sensor 118 on the external actuator 104 as well.

In accordance with an embodiment, the external actuator 104 comprises an opening, the internal actuator 102 comprising the mirror plate 108A and being mounted on the external actuator 104 so as to cover said opening on a first side of said external actuator 104, and so as to create an optical path from a light source, located on a second side opposite to said first side, to the mirror plate 108A through said opening. The internal actuator 102 is directly soldered onto the external actuator 104 for electrical as well as mechanical connection through the opening in the external actuator 104. An exemplary implementation of direct soldering of the internal actuator 102 onto the external actuator 104 through the opening in the external actuator 104 is described in detail, for example, in FIG. 3D.

FIG. 1D is a schematic top view of the micromechanical resonator assembly of FIG. 1A, in accordance with an embodiment of the present disclosure. FIG. 1D is described in conjunction with elements from FIGS. 1A, 1B, and 1C. With reference to FIG. 1D, there is shown a top view of the micromechanical resonator assembly 100 of FIG. 1A. In the top view, the micromechanical resonator assembly 100 appears to have a rectangular shape. There is further shown a wire bond 126 which is configured to provide the electrical connections to the internal actuator 102 and the external actuator 104 from the driving part 112. The internal sensor 118 of the internal actuator 102 is electrically connected to the driving part 112 through the second wire 122 and the external actuator 104 is electrically connected to the driving part 112 through the first wire 114 (shown in FIG. 1C). The first wire 114 and the second wire 122 collectively represent the wire bond 126. The screw 116 (also represented as dotted circular hole) represents the mechanical fixation of the external actuator 104 on the mounting base 106. The top view of the micromechanical resonator assembly 100 also represents the glued internal actuator 102 which is mounted on the external actuator 104.

Thus, the micromechanical resonator assembly 100 provides an effective actuation energy to the oscillation body 108 (i.e. the micro mirror plate 108A mounted on the spring 108B) of the internal actuator 102 by use of the external actuator 104. The external actuator 104 excites the one or more eigen frequencies (i.e. resonant or near resonant frequencies) of the oscillation body 108 by virtue of the driving signal which is provided by the driving part 112. The driving signal (i.e. sine wave) causes the bending mode vibration of the oscillating part 110 of the external actuator 104 which further transfers the effective actuation energy to the oscillation body 108 of the internal actuator 102. Due to the effective actuation energy, the micro mirror plate 108A of the oscillation body 108 oscillates about its axis and achieves the extremely large scan angles upto 180°. Thus, the micromechanical resonator assembly 100 provides extremely large scan angles up to 180° for one dimensional (1D) oscillation body because of the transfer of high actuation energy to the oscillation body 108. The micromechanical resonator assembly 100 provides extremely fast start-up time that is less than 1 s in comparison to the conventional micromechanical resonator assembly. Moreover, the micromechanical resonator assembly 100 is manufacturable at high volume because of the use of semiconductor assembly process. The micromechanical resonator assembly 100 is cost efficient and has robust quality. Additionally, the micromechanical resonator assembly 100 provides a reduced power consumption and easy handling when in operation. The micromechanical resonator assembly 100 may also be referred as a micro-mirror assembly, a micro-mirror external piezo system, or a MEMS mirror assembly. The micromechanical resonator assembly 100 is used in laser projection or laser scanning system such as augmented reality (AR) or virtual reality (VR) glasses or helmets, light detection and ranging (LiDAR) system and the like.

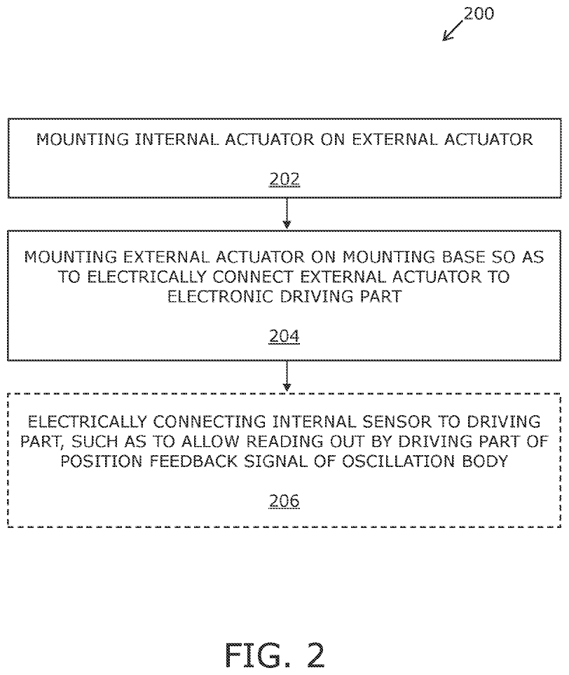

FIG. 2 is a flowchart of a method of fabricating a micromechanical resonator assembly, in accordance with an embodiment of the present disclosure. FIG. 2 is described in conjunction with elements from FIGS. 1A, 1B, 1C, and 1D. With reference to FIG. 2, there is shown a method 200 of fabricating a micromechanical resonator assembly such as the micromechanical resonator assembly 100 of FIG. 1A. The method 200 is executed, for example, by the micromechanical resonator assembly 100 (of FIG. 1A). The method 200 includes steps 202 to 206.

At step 202, the method 200 comprises mounting an internal actuator (such as the internal actuator 102) on an external actuator (such as the external actuator 104) so as to form a coupled oscillating system. The micromechanical resonator assembly 100 includes the internal actuator 102 and the external actuator 104. The internal actuator 102 is mounted on the external actuator 104 either by gluing or direct soldering. The external actuator 104 provides an actuation energy to the internal actuator 102 which tends the internal actuator 102 to oscillate about its axis. In this way, the internal actuator 102 and the external actuator 104 collectively form the coupled oscillating system. The internal actuator 102 may also be referred as a micro mirror chip with spring mounted mirror plate. The external actuator 104 may also be referred as an external piezo actuator.

In accordance with an embodiment, the internal actuator 102 comprises an internal sensor (such as the internal sensor 118). The internal sensor 118 is used in a case where stable amplitude operation of the oscillation body 108 is required.

At step 204, the method 200 further comprises mounting the external actuator 104 on a mounting base (such as the mounting base 106) so as to electrically connect the external actuator 104 to an electronic driving part (such as the electronic driving part 112), for allowing excitation of an oscillation body (such as the oscillation body 108) of the internal actuator 102 by transfer of energy from an oscillating part (such as the oscillating part 110) to the oscillation body 108. The electrical connection between the external actuator 104 and the driving part 112 provides a driving signal (e.g. a sine wave that is an amplitude changing drive signal with a selected frequency) to the external actuator 104. The oscillating part 110 of the external actuator 104 performs a bending mode vibration because of the driving signal (i.e. sine wave). The bending mode vibration of the oscillating part 110 transfers an actuation energy to the oscillation body 108. The actuation energy excites the one or more eigen frequencies of the oscillation body 108 and tends it to oscillate about its axis.

In accordance with an embodiment, the external actuator 104 is mounted on the mounting base 106 by mechanical fixation such as clamping, or by gluing. The external actuator 104 is mounted on the mounting base 106 either by clamping, for example, by use of the screw 116 (as shown in FIG. 1C) or by gluing.

In accordance with an embodiment, the electrical connection between the external actuator 104 and the driving part 112 is obtained through wire bonding. For example, the external actuator 104 is electrically connected to the driving part 112 by use of the first wire 114 (as shown in FIG. 1C) under the wire bonding technique. The use of the wire bonding technique results into low cost of the micromechanical resonator assembly 100.

In accordance with an embodiment, alternatively, the electrical connection between the external actuator 104 and the driving part 112 is obtained through direct soldering of the external actuator 104 onto the mounting base 106, so as to ensure both electrical connection and fixation of the external actuator 104 on the mounting base 106. The direct soldering of the external actuator 104 onto the mounting base 106 provides the electrical connection between the external actuator 104 and the driving part 112 as well as fixation of the external actuator 104 onto the mounting base 106. The direct soldering of the external actuator 104 onto the mounting base 106 provides robustness to the micromechanical resonator assembly 100.

In an embodiment, at step 206, the method 200 further comprises electrically connecting the internal sensor 118 to the driving part 112, such as to allow reading out by the driving part 112 of a position feedback signal of the oscillation body 108. For a stable amplitude operation of the oscillation body 108 of the internal actuator 102, the external actuator 104 is driven in a closed loop by use of the internal sensor 118. The internal sensor 118 allows the driving part 112 to read out the position feedback signal of the oscillation body 108. The position feedback signal of the oscillation body 108 is applied to the closed loop which enables the external actuator 104 to control oscillations of the oscillation body 108 and results into the stable amplitude operation of the oscillation body 108.

In accordance with an embodiment, the electrical connection between the internal sensor 118 and the driving part 112 is obtained by wire bonding or flexible cable soldering. For example, the internal sensor 118 is electrically connected to the driving part 112 by use of the second wire 122 (as shown in FIG. 1C) under wire bonding technique. Aluminium (Al) or gold (Au) wires are used to electrically connect the bond pads of internal actuator 102 (or the micro mirror chip) to the bonning pads of the mounting base 106. Optionally, the flexible cable soldering is also used for the electrical connection between the internal sensor 118 and the driving part 112.

In accordance with an embodiment, the internal actuator 102 is mounted on the external actuator 104 by gluing. The internal actuator 102 (or the micro mirror chip) is mounted on the external actuator 104 by use of the glue 120 (shown in FIG. 1C).

In accordance with an embodiment, the electrical connection between the internal sensor 118 and the driving part 112 is obtained by direct soldering of the internal sensor 118 onto the external actuator 104, so as to ensure both electrical connection and fixation of the internal sensor 118 on the external actuator 104. The soldering conductor wires are used for direct soldering of the internal sensor 118 onto the external actuator 104.

In accordance with an embodiment, the method 200 further comprises creating an opening in the external actuator 104 prior to mounting the internal actuator 102 on the external actuator 104, the internal actuator 102 comprising a mirror plate (such as the micro mirror plate 108A), and mounting the internal actuator 102 on the external actuator 104 so as to cover said opening on a first side of the external actuator 104, such that an optical path is created from a light source, located on a second side opposite to said first side, to the mirror plate (such as the micro mirror plate 108A) through said opening. Optionally, for direct soldering of the internal actuator 102 (or the micro mirror chip) onto the external actuator 104 (or external piezo actuator), the opening is created in the external actuator 104 prior to mounting of the internal actuator 102 on the external actuator 104. The created optical path from the light source to the mirror plate (such as the micro mirror plate 108A of the oscillation body 108) provides reflection of light at a required angle which is used in laser scanning or laser projection systems.

The steps 202 to 206 are only illustrative and other alternatives can also be provided where one or more steps are added, one or more steps are removed, or one or more steps are provided in a different sequence without departing from the scope of the claims herein.

FIG. 3A is a schematic side view of a micromechanical resonator assembly, in accordance with another embodiment of the present disclosure. FIG. 3A is described in conjunction with elements from FIGS. 1A, 1B, 1C, and 1D. With reference to FIG. 3A, there is shown a micromechanical resonator assembly 300A. The micromechanical resonator assembly 300A includes an internal actuator 302, an external actuator 304 and a mounting base 306. The internal actuator 302 includes an oscillation body 308 which further includes a micro mirror plate 308A (not visible here) mounted on a spring 308B. The external actuator 304 includes a piezoelectric layer 304A. The mounting base 306 includes electronic components 312A and 312B which constitute a driving part (such as the driving part 112 of FIG. 1A) of the mounting base 306. There is further shown a flexible cable 310, a wire 314, a screw 316, a glue 318 and a housing 320.

The internal actuator 302, the external actuator 304 and the mounting base 306 correspond to the internal actuator 102, the external actuator 104 and the mounting base 106, respectively, of the micromechanical resonator assembly 100. Moreover, the piezoelectric layer 304A of the external actuator 304, the oscillation body 308 with the micro mirror plate 308A and the spring 308B, and the electronic components 312A and 312B which constitute the driving part of the mounting base 306 correspond to the piezoelectric layer 104A of the external actuator 104, the oscillation body 108 with the micro mirror plate 108A and the spring 108B, and the electronic components 112A and 112B which constitute the driving part 112 of the mounting base 106, respectively, of the micromechanical resonator assembly 100 (shown in FIG. 1C). The wire 314, the screw 316, the glue 318 and the housing 320 correspond to the first wire 114, the screw 116, the glue 120 and the housing 124, respectively, of the micromechanical resonator assembly 100 (shown in FIG. 1C).

Alternatively stated, electrical and mechanical connections of the micromechanical resonator assembly 300A correspond to the electrical and mechanical connections of the micromechanical resonator assembly 100 (of FIG. 1C) except a difference. The difference is that the internal actuator 302 (or the micro mirror chip) is electrically connected to the driving part of the mounting base 306 by use of the flexible cable 310 instead of the wire bonding (shown in FIG. 1C). The flexible cable 310 is used to provide the electrical connection between the internal actuator 302 and the driving part of the mounting base 306. The flexible cable 310 provides a flexibility to the micromechanical resonator assembly 300A. The flexible cable 310 may also be referred to as a flex cable.

FIG. 3B is a schematic side view of a micromechanical resonator assembly, in accordance with yet another embodiment of the present disclosure. FIG. 3B is described in conjunction with elements from FIGS. 1A, 1B, 1C, 1D, and 3A. With reference to FIG. 3B, there is shown a micromechanical resonator assembly 300B. The micromechanical resonator assembly 300B includes a glue 322 and a wire 324.

The electrical and mechanical connections of the micromechanical resonator assembly 300B correspond to the electrical and mechanical connections of the micromechanical resonator assembly 300A (of FIG. 3A) except a few differences. The differences are that in the micromechanical resonator assembly 300B, the external actuator 304 is mounted onto the mounting base 306 by use of the glue 322 instead of clamping the external actuator 304 onto the mounting base 306 by use of the screw 316 in the micromechanical resonator assembly 300A (of FIG. 3A). Additionally, the internal actuator 302 (or the micro mirror chip) is electrically connected to the driving part (such as the driving part 112 of FIG. 1A) of the mounting base 306 by use of the wire 324 through wire bonding inspite of soldering the flexible cable 310 as shown in the micromechanical resonator assembly 300A.

FIG. 3C is a schematic side view of a micromechanical resonator assembly, in accordance with yet another embodiment of the present disclosure. FIG. 3C is described in conjunction with elements from FIGS. 1A, 1B, 1C, 1D, 3A, and 3B. With reference to FIG. 3C, there is shown a micromechanical resonator assembly 300C.

The micromechanical resonator assembly 300C corresponds to the micromechanical resonator assembly 300B (of FIG. 3B) except a difference. The difference is that in the micromechanical resonator assembly 300C, the external actuator 304 is mounted onto the mounting base 306 by direct soldering 326 (instead of using glue or mechanical fixation, such as a screw). The direct soldering 326 of the external actuator 304 onto the mounting base 306 provides the electrical connection between the external actuator 304 and the driving part of the mounting base 306 as well as the mechanical fixation of the external actuator 304 onto the mounting base 306.

FIG. 3D is a schematic side view of a micromechanical resonator assembly, in accordance with yet another embodiment of the present disclosure. FIG. 3D is described in conjunction with elements from FIGS. 1A, 1B, 1C, 1D, 3A, 3B, and 3C. With reference to FIG. 3D, there is shown a micromechanical resonator assembly 300D. In the micromechanical resonator assembly 300D, the external actuator 304 comprises an opening 328.

The micromechanical resonator assembly 300D corresponds to the micromechanical resonator assembly 300A (of FIG. 3A) except a difference. The difference is that in the micromechanical resonator assembly 300D, the internal actuator 302 is directly soldered onto the external actuator 304 through the opening 328 instead of using the glue 318 for mounting as shown in FIGS. 3A, 3B and 3C. The direct soldering of the internal actuator 302 onto the external actuator 304 provides the electrical connection between the internal actuator 302 and the driving part of the mounting base 306 as well as mechanical fixation of the internal actuator 302 onto the external actuator 304. Additionally, the opening 328 of the external actuator 304 provides an optical path from a light source to the mirror plate 308A of the oscillation body 308 in order to project the light at a certain angle.

FIG. 3E is a schematic top view of the micromechanical resonator assembly 300D of FIG. 3D, in accordance with an embodiment of the present disclosure. FIG. 3E is described in conjunction with elements from FIGS. 1A, 1B, 1C, 1D, 3A, 3B, 3C, and 3D. With reference to FIG. 3E, there is shown a top view of the micromechanical resonator assembly 300D of FIG. 3D.

The top view of the micromechanical resonator assembly 300D corresponds to the top view of the micromechanical resonator assembly 100 (of FIG. 1D) except a few differences. The differences are that in the micromechanical resonator assembly 300D, the internal actuator 302 is directly soldered onto the external actuator 304 through the opening 328 of the external actuator 304. The direct soldering of the internal actuator 302 onto the external actuator 304 provides the electrical connection between the internal actuator 302 and the driving part of the mounting base 306 and hence, the direct soldering is used as an alternative of the wire bond 126 used in the micromechanical resonator assembly 100 (of FIG. 1D).

Moreover, the direct soldering of the internal actuator 302 onto the external actuator 304 provides mechanical fixation of the internal actuator 302 onto the external actuator 304 and hence, the direct soldering is used as an alternative of the glue 120 used in the micromechanical resonator assembly 100 (of FIG. 1D).

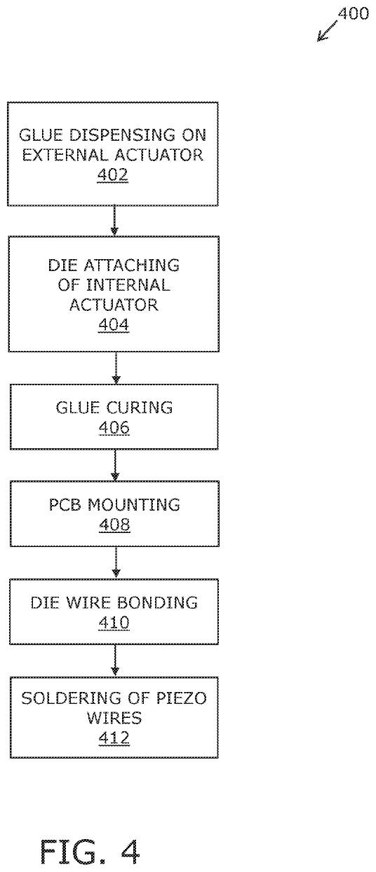

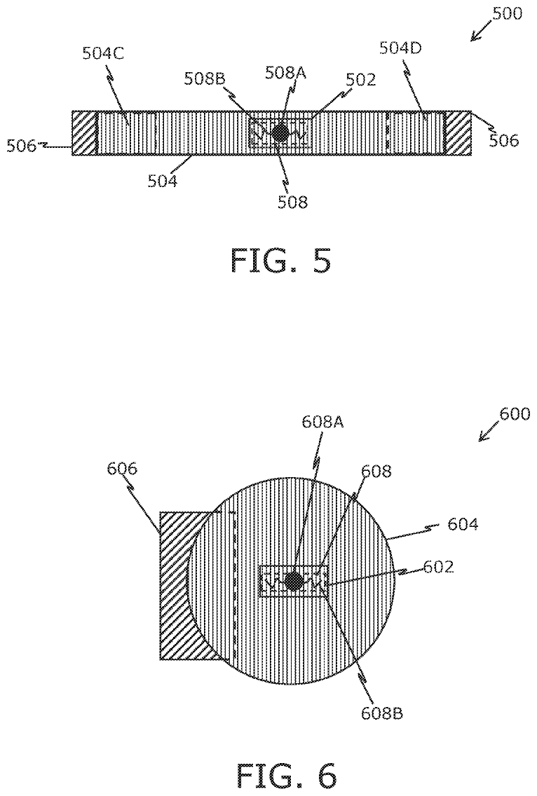

FIG. 4 is a flowchart of a method that depicts fabrication details of a micromechanical resonator assembly, in accordance with an embodiment of the present disclosure. FIG. 4 is described in conjunction with elements from FIGS. 1A, 1B, 1C, 1D, 2, 3A, 3B, 3C, 3D, and 3E. With reference to FIG. 4, there is shown a method 400 that depicts a step-by-step fabrication of a micromechanical resonator assembly such as the micromechanical resonator assembly 100 (of FIG. 1A). The method 400 is executed by the micromechanical resonator assembly 100 (of FIG. 1A). The method 400 includes steps 402, 404, 406, 408, 410, and 412.

At step 402, the method 400 comprises glue dispensing on an external actuator. For example, the external actuator 104 (of FIG. 1A) includes the first end 104C and the second end 104D. The glue 120 (of FIG. 1C) is dispensed on the second end 104D of the external actuator 104. The external actuator 104 may also be referred as a piezo ceramic actuator plate.

At step 404, the method 400 comprises die attaching of an internal actuator on the external actuator. For example, the internal actuator 102 (of FIG. 1A) is mounted on the external actuator 104 by use of the glue 120. The internal actuator 102 may also be referred as a micro mirror die. Alternatively stated, the internal actuator 102 (or the micro mirror die) is attached to the external actuator 104 by use of the glue 120.

At step 406, the method 400 comprises glue curing for mounting of the internal actuator (or the micro mirror die) to the external actuator. The glue curing refers to hardening or toughening of the glue 120. The glue curing is performed by heating the glue 120 so that the mounting of the internal actuator 102 (or the micro mirror die) can be executed onto the external actuator 104.

At step 408, the method 400 comprises PCB mounting of the external actuator on a mounting base. For example, the external actuator 104 with the attached internal actuator 102 (or the micro mirror die) is mounted to the mounting base 106 by mechanical clamping, such as by use of the screw 116 (of FIG. 1C). Alternatively, the mounting of the external actuator 104 onto the mounting base 106 may be performed either by gluing or by direct soldering.

At step 410, the method 400 comprises die wire bonding of the internal actuator to the mounting base. For example, the internal actuator 102 is electrically connected to the mounting base 106 by use of the second wire 122 (of FIG. 1C through the wire bonding technique. The aluminium (Al) or gold (Au) wires are used to connect the bond pads of the internal actuator 102 to the boning pads of the mounting base 106.

At step 412, the method 400 comprises soldering of piezo wires for the electrical connection between the external actuator and the mounting base. For example, the external actuator 104 is electrically connected to the mounting base 106 by soldering of piezo wires (or conductor wires) between the external actuator 104 (or the piezo actuator pad) and the mounting base 106 (or the mounting base pad areas).

The steps 402 to 412 are only illustrative and other alternatives can also be provided where one or more steps are added, one or more steps are removed, or one or more steps are provided in a different sequence without departing from the scope of the claims herein.

FIG. 5 is a schematic top view of a micromechanical resonator assembly, in accordance with another embodiment of the present disclosure. FIG. 5 is described in conjunction with Clements from FIGS. 1A. 1B, 1C, 1D, 2, 3A, 3B, 3C, 3D, 3E, and 4. With reference to FIG. 5, there is shown a micromechanical resonator assembly 500 that includes an internal actuator 502, an external actuator 504 and a mounting base 506. The internal actuator 502 includes an oscillation body 508 which further includes a micro mirror plate 508A mounted on a spring 508B. The external actuator 504 includes a first end 504C and a second end 504D. The oscillation body 508 is represented by a dashed rectangular box which is used for illustration purpose only and does not form a part of circuitry.

The internal actuator 502, the external actuator 504 and the mounting base 506 correspond to the internal actuator 102, the external actuator 104 and the mounting base 106, respectively, of the micromechanical resonator assembly 100.

In the top view, the micromechanical resonator assembly 500 appears to have a rectangular shape and a double-sided clamping of the external actuator 504. The external actuator 504 appears to as a rectangular piezo beam in the top view. In the double-sided (or two-sided) clamping of the external actuator 504, the external actuator 504 is mounted on the mounting base 506 by use of both the ends such as the first end 504C and the second end 504D. And the internal actuator 502 is mounted between the first end 504C and the second end 504D, that is at centre or near to centre of the external actuator 504. The micro mirror plate 508A of the oscillation body 508 appears to have a circular shape in the top view of the micromechanical resonator assembly 500.

FIG. 6 is a schematic top view of a micromechanical resonator assembly, in accordance with yet another embodiment of the present disclosure. FIG. 6 is described in conjunction with elements from FIGS. 1A, 1B, 1C, 1D, 2, 3A, 3B, 3C, 3D, 3E, and 4. With reference to FIG. 6, there is shown a micromechanical resonator assembly 600 that includes an internal actuator 602, an external actuator 604 and a mounting base 606. The internal actuator 602 includes an oscillation body 608 which further includes a micro mirror plate 608A mounted on a spring 608B. The oscillation body 608 is represented by a dashed rectangular box which is used for illustration purpose only and does not form a part of circuitry.

The internal actuator 602, the external actuator 604 and the mounting base 606 correspond to the internal actuator 102, the external actuator 104 and the mounting base 106, respectively, of the micromechanical resonator assembly 100.

In the top view, the micromechanical resonator assembly 600 appears to have a circular shape. More specifically, in the micromechanical resonator assembly 600, the external actuator 604 has the circular shape. The external actuator 604 is mounted on the mounting base 606 by use of a portion of its circular periphery. The internal actuator 602 is mounted at the centre of the external actuator 604. In another embodiment, the external actuator 604 may have different shapes, such as elliptical or trapezoidal shape.

FIG. 7 is an illustration of an exemplary implementation of a micromechanical resonator assembly in a laser scanning or laser projection system, in accordance with an embodiment of the present disclosure. FIG. 7 is described in conjunction with elements from FIGS. 1A, 1B, 1C, 1D, 2, 3A, 3B, 3C, 3D, 4, 5, and 6. With reference to FIG. 7, there is shown a laser projection system 700 that includes a light engine 702. The light engine 702 further includes a microcontroller 704, a red-green-blue (RGB) laser 706, a plurality of optical elements 708, and a micromechanical resonator assembly 710. There is further shown a plurality of projected rays 712, a reflection surface 714 and a human eye 716. The plurality of optical elements 708 includes an optical lens 708A and a prism 708B.

The laser projection system 700 (or a laser projector) is configured to project a laser beam on a screen in order to create a moving image either for entertainment or a professional use. The laser projection system 700 uses the RGB laser 706 and therefore, creates a coloured image on the screen. The laser projection system 700 is used in head-up display projection, laser headlights, active scene or object lightning, projection of information, for laser scanning in a light detection and ranging (LiDAR) system, laser projection in augmented reality (AR)/virtual reality (VR) glasses or helmets, and the like.

The light engine 702 is configured to control the intensity (or brightness) of the created image, colour of the image, projection angle of the image and resolution of the image by use of a control circuitry (such as the microcontroller 704), the plurality of optical elements 708 and the micromechanical resonator assembly 710. The light engine 702 is based on an optical micro-electro-mechanical (MEM) technology which uses a micro-mirror device (such as the micromechanical resonator assembly 710).

The microcontroller 704 (also represented as μC) is configured to control functioning of all the components of the light engine 702 such as the RGB laser 706, the plurality of optical elements 708 and the micromechanical resonator assembly 710. The microcontroller 704 (i.e. μC) controls a light coming from a light source and provides the controlled light to the RGB laser 706.

The RGB laser 706 is configured to produce a coloured image on the screen. The different colours of the RGB laser 706 that is red, green and blue get combined into each other in a certain ratio in order to produce various colours of the image.

The optical lens 708A of the plurality of optical elements 708 is configured to focus the RGB lights from the RGB laser 706 to the prism 708B. The prism 708B is configured to receive the focused lights from the optical lens 708A and provides it to the micromechanical resonator assembly 710. In this way, the plurality of optical elements 708 are used to focus the lights from the RGB laser 706 to the micromechanical resonator assembly 710.

The micromechanical resonator assembly 710 corresponds to the micromechanical resonator assembly 100 (of FIGS. 1A-ID) and its alternative implementation forms which have been described in FIGS. 3A-3D. 5 and 6. The micromechanical resonator assembly 710 is configured to project the received focused light from the plurality of optical elements 708 to the reflection surface 714 by use of the plurality of projected rays 712. The micromechanical resonator assembly 710 is configured to produce an image with high resolution since each mirror of the micromechanical resonator assembly 710 is configured to create one or more pixels of the produced image. The micromechanical resonator assembly 710 may also be referred as a MEMS mirror with external piezo mounting. In another implementation, the micromechanical resonator assembly 710 may include an array of micro-mirrors.

The plurality of projected rays 712 get reflected from the reflection surface 714 (e.g. reflection surface of google glass) and enter into the human eye 716. Due to the reflection of the plurality of projected rays 712 from the reflection surface 714, a coloured and moving image become visible to the human eye 716.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

1. A micromechanical resonator assembly comprising:
an internal actuator which comprises an oscillation body configured to oscillate about one or more axes, the oscillation body having one or more eigenfrequencies,
an external actuator which comprises an oscillating part, and
a mounting base which comprises an electronic driving part,
the internal actuator being mounted with the external actuator so as to form a coupled oscillation system, the external actuator bring mounted on the mounting base and being electrically connected to the electronic driving part, for allowing excitation of the oscillation body of the internal actuator by transfer of energy from the oscillating part to the oscillation body.

2. The micromechanical resonator assembly according to claim 1, wherein the electrical connection between the external actuator and the driving part comprises at least one ground connection and two sensing signal connections.

3. The micromechanical resonator assembly according to claim 1, wherein the electrical connection between the external actuator and the driving part is obtained
through wire bonding, or
through direct soldering of the external actuator onto the mounting base so as to ensure both electrical connection and fixation of the external actuator on the mounting base.

4. The micromechanical resonator assembly according to claim 1, wherein
the electrical connection between the external actuator (104, 304, 504, 604) and the driving part (112) is obtained through wire bonding, and
the external actuator is mounted on the mounting base by mechanical fixation such as clamping, or by gluing.

5. (canceled)

6. The micromechanical resonator assembly according to claim 1, wherein the internal actuator comprises an internal sensor electrically connected to the driving part, such as to allow reading out by the driving part of a position feedback signal of the oscillation body.

7. The micromechanical resonator assembly according to claim 6, wherein the electrical connection between the internal sensor and the driving part is obtained
by wire bonding or flexible cable soldering, or
by direct soldering of the internal sensor onto the external actuator, so as to ensure both electrical connection and fixation of the internal sensor on the external actuator, so as to ensure both electrical connection and fixation of the internal sensor on the external actuator.

8. The micromechanical resonator assembly according to claim 1, wherein the internal actuator is mounted on the external actuator by gluing.

9. (canceled)

10. The micromechanical resonator assembly according to claim 1, wherein the external actuator comprises at least one of the following:
at least two ends and is mounted on the mounting base by one of said two ends, the internal actuator being mounted on the external actuator the other one of said two ends,
at least two ends and is mounted on the mounting base by each of said two ends, the internal actuator being mounted on the external actuator between said two ends,
a circular shape and is mounted on the mounting base by a portion of its periphery, the internal actuator being mounted on the external actuator at the centre of said external actuator,
an opening, the internal actuator comprising a mirror olate and being mounted on the external actuator so as to cover said opening on a first side of said external actuator, and so as to create an optical path from a light source, located on a second side opposite to said first side, to the mirror plate through said opening.

11.-13. (canceled)

14. The micromechanical resonator assembly according to claim 1, said assembly being a micro mirror scanner, the external actuator being a piezoelectric actuator and the internal actuator comprising a piezoelectric or electrostatic sensor.

15. The micromechanical resonator assembly according to claim 14, wherein the external piezoelectric actuator comprises at least one of the following:
at least one piezoelectric layer and at least one passive layer, and is mounted on the mounting base through its passive layer,
a plurality of segments each exhibiting different bending and torsion axis excitation frequency.

16. (canceled)

17. The micromechanical resonator assembly according to claim 14, wherein the oscillation body of the internal actuator comprises a wafer-level vacuum encapsulated spring-mirror plate system.

18. A light engine for laser scanning or laser projection system comprising a micromechanical resonator assembly according to claim 1.

19. A laser projection or scanning system comprising a light engine according to claim 18, such as AR/VR glasses or helmet, or a Lidar system.

20. A method of fabricating a micromechanical resonator assembly comprising an internal actuator which comprises an oscillation body configured to oscillate about one or more axes, an external actuator which comprises an oscillating part, and a mounting base which comprises electronic driving part, said method comprising mounting the internal actuator on the external actuator so as to form a coupled oscillating system, and mounting the external actuator on the mounting base so as to electrically connect the external actuator to the electronic driving part, for allowing excitation of the oscillation body of the internal actuator, 302, 502, by transfer of energy from the oscillating part to the oscillation body.

21. The method according to claim 20, wherein the electrical connection between the external actuator and the driving part is obtained
through wire bonding, or
through direct soldering of the external actuator onto the mountain base, so as to ensure both electrical connection and fixation of the external actuator on the mounting base so as to ensure both electrical connection and fixation of the external actuator on the mounting base.

22. The method according to claim 20, wherein
the electrical connection between the external actuator and the driving part is obtained through wire bonding, and
the external actuator is mounted on the mounting base by mechanical fixation such as clamping, or by gluing.

23. (canceled)

24. The method according to claim 20, the internal actuator comprising an internal sensor, said method comprising electrically connecting the internal sensor to the driving part, such as to allow reading out by the driving part of a position feedback signal of the oscillation body.

25. The method according to claim 24, wherein the electrical connection between the internal sensor and the driving part is obtained
by wire bonding or flexible cable soldering, or
by direct soldering of the internal sensor onto the external actuator, so as to ensure both electrical connection and fixation of the internal sensor on the external actuator.

26. The method according to claim 20, wherein the internal actuator is mounted on the external actuator by gluing.

27. (canceled)

28. The method according to claim 20, comprising creating an opening in the external actuator prior to mounting the internal actuator on the external actuator, said internal actuator comprising a mirror plate, and mounting said internal actuator on the external actuator so as to cover said opening on a first side of said external actuator, such that an optical path is created from a light source, located on a second side opposite to said first side, to the mirror plate through said opening.
